(19) United States
(12) Patent Application Publication
(10) Pub. No.: US 2026/0350166 A1
(43) Pub. Date: Nov. 5, 2026

(54) NETWORK FLOW MODEL FOR SECURITY GRAPH BASED THREAT DETECTION

(71) Applicant: Microsoft Technology Licensing, LLC, Redmond, WA (US)

(72) Inventors: Aviv David ELDAN, Tel Aviv (IL); Ron MATCHORO, Zipori Shir (IL); Andrey KARPOVSKY, Kiryat Motzkin (IL)

(21) Appl. No.: 19/195,622

(22) Filed: Apr. 30, 2025

(51) Int. Cl. G06F 21/56

(52) U.S. Cl. CPC G06F 21/566; G06F 2221/033

(57) ABSTRACT

In various examples, a security graph is generated based on computing resources within a computing environment, and a machine learning model is used to determine placement information for threat scanners. For example, control plane and/or data plane logs are used to generate the security graph which includes source and sink nodes. Continuing this example, the machine learning model generates predictions based on the security graph, and the predictions are used to determine the optimal placement of threat scanners within the computing environment.

### BACKGROUND

Computer security and security computing resources, especially in the cloud computing settings, are critical domain that focuses on protecting data, applications, and infrastructures involved in the transmission of data and execution of application. As organizations increasingly leverage computing resources and services provided by computing resource service providers, ensuring the security of these environments becomes paramount. Malware and threat scanning aimed at detecting and mitigating malicious software and protecting sensitive data are important aspects of maintaining security in computing environments. In particular, malware, ransomware, computer viruses, and other malicious source code can compromise data integrity, confidentiality, and availability. As a result, effective malware detection and prevention strategies are essential to safeguard sensitive information and maintain the operational continuity of cloud-based services, on-premises computing environments, and/or hybrid computing environments.

### SUMMARY

Embodiments described herein are directed to generating a security graph based on a computing resource environment and analyzing the security graph using a machine learning model to determine locations for threat scanners and/or other security devices to perform malware detection and spread prevention within the computing resource environment. For example, the security graph represents the movement of data within the computing environment from sources to sinks and models potential malware spread as a flow network. Continuing this example, the security graph is analyzed using various techniques including machine learning models to determine, based on a budget and/or amount of computing resources available, optimal locations for threat scanners (e.g., malware scanners), as well as the types of data to scan and when to perform scans and/or other security operations.

In various embodiments, the security graph enables the machine learning model and/or another tool to generate prediction for malware propagation paths within the computing environment and determine optimal threat scanner placement to mitigate security risks. In various embodiments, by integrating data plane logs and control plane logs, the security graph can be enriched or otherwise improved thereby increasing the accuracy of malware detection as well as providing actionable insights for security administrators to prioritize alerts and recommendations based on the likelihood of malware spread as predicted by the machine learning model. For example, augmenting the security graph with data obtained from the data plane logs and/or the control plane log, enables the machine learning model to better generate predictions associated with the movement of malware and the risks associated with the movement of malware to particular sinks (e.g., computing resources such as virtual machines, datastores, containers, servers, etc.).

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced;

FIG. 2 depicts an environment in which a security graph represents the movement of data within the computing environment from sources to sinks, in accordance with at least one embodiment;

FIG. 3 depicts an environment in which a security graph represents the movement of data within the computing environment from sources to sinks, in accordance with at least one embodiment;

FIG. 4 depicts an environment in which a threat scanner operates within a computing environment, in accordance with at least one embodiment;

FIG. 5 depicts an example process flow for determining location information for threat scanners within a computing environment, in accordance with at least one embodiment;

FIG. 6 depicts an example process flow for updating a security graph and determining location information for threat scanners within a computing environment, in accordance with at least one embodiment;

FIG. 7 depicts an example process flow for returning a response to a query of a dynamic view, in accordance with at least one embodiment; and

FIG. 8 is a block diagram of an exemplary computing environment suitable for use in implementations of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a standalone application, a service or hosted service (standalone or in combination with another hosted service), or a plug-in to another product, to name a few.

Aspects of the present disclosure relate to technology for improving threat detection systems within a computing environment by generating and/or enriching security graphs with data plane and/or control plane information to enable a machine learning model to predict risks and determine placement information for threat scanners to mitigate risks, addressing significant limitations in existing systems. Malware, ransomware, and other malicious code pose a serious security risk to computing environments, especially when affecting critical assets. Thus, effective detection of security risk and the prevention of the spread of malicious code are critical components of protecting a computing environment. Conventional threat detection systems focused on malware detection using scanners at specific computing resources within a computing environment can mitigate some of the risk; however, detection of malware across the computing environment as a whole and prevention of the spread of malicious code are still issues.

In particular, conventional threat detection systems face significant challenges in effectively detecting and preventing the spread of malware and other malicious code due to the complex structure of modern computing environments as well as the limitations on scanning resources such as the amount of computing resources available for scanning operations and the amount of data to be scanned. For example, computing environments often have complex structures including physical and/or logical computing resources that can be distributed between on premises environments, cloud environments, and/or hybrid environments. Continuing this example, the different types of computing resources include data repositories, virtual machines, containers, network devices, and other computing resources that all pose different risks with many different paths data that can travel within the computing environment between computing resources. Furthermore, traditional methods often fail to account for the unobvious paths through which malware and/or other malicious code can propagate, leading to inadequate protection of critical assets. Further adding to the complexity is that these computing environments are often multi-tenant and include users with different permission sets and access levels, which makes it difficult for conventional systems to accurately gauge threats.

Furthermore, conventional systems can overwhelm users with hundreds of alerts on uploads and/or downloads to a plurality of storage devices that may include malware or other threats without prioritizing alerts that pose greater risks and should be mitigated first. For example, these conventional alert systems fail to indicate how likely the application and/or user is to spread the malware, thereby limiting the effectiveness and usefulness of such alerts to the user. As a result, these conventional threat detection systems fail to help security administrators prioritize security recommendations making it more difficult for security administrators to mitigate risks based on the threat posed.

In addition, since computing resources are limited, conventional threat detection systems rely on scanning operations that have a limited budget. For example, due to the complexity and size of most computing environments, it is difficult, if not impossible, to scan all the data traveling within the computing environment or even all the data traveling in or out of the computing environment. Furthermore, these computing environments are responsible for executing applications and/or performing other operations and, therefore, have a limited amount of additional computing resources to dedicate to scanning and/or detecting threats. For example, scanning and/or other threat detection operations can interfere with the indented behavior of a computing environment. Conventional systems often fail to optimize the placement on scanners and/or activation of scans due to the complexity described above.

In one example, once malware is detected in a storage device in a computing environment, using conventional threat detection systems, security administrators are unable to determine if this storage device is unconnected (e.g., not used by anyone), and therefore the attack surface is low, or if the storage device is used by many applications/users, that can download this malware and move it to an active environment where the malware can be executed (e.g., a virtual machine). Surfacing this information to users is especially important in the case where the data can flow to critical computing resources.

Aspects of the technology described herein improve the functioning of threat detection systems and malware scanning in light of these shortcomings in existing systems by providing a solution that uses a security graph to model or otherwise predict the flow of security risks within a computing environment to determine an optimized placement of threat scanner and/or other security devices within the computing environment. For instance, embodiments described herein generally relate to a security graph-based threat detection tool that is capable of modeling the spread of malicious code and other threats as a flow network over a security graph. For example, this approach involves constructing a directed graph where edges represent potential data movement and nodes signify assets such as storage accounts, virtual machines, and/or user identities.

In various embodiments, a security graph is enriched or otherwise augments with information obtained from data plane logs, control plane logs, and/or other logs with information such as sensitive resources that are reachable from particular users and/or applications. In this manner, the security graph-based threat detection tool is capable of generating more accurate prioritization information for particular threats, determining the optimal placement of threat scanners, and/or optimizing a budget of computing resources needed to mitigate threats without interfering with the operations of the computing environment. In various embodiment, the security graph-based threat detection tool prioritizes recommendations based on a prediction generated by a machine learning model based on the security graph. For example, the machine learning model predicts that a particular storage account is more likely to spread malware, as a result of malware being uploaded to a particular storage device. Continuing this example, the security graph based threat detection tool generates a recommendation to place a threat scanner at the particular storage device and/or associated with the particular storage account in order to more efficiently use computing resources to prevent and/or mitigate threats.

In various embodiments, the security graph based threat detection tool generates and/or recommends alerts to notify users about potential threats and/or the spread of potential threats. In addition, in some embodiments, the security graph-based threat detection tool determine locations and/or other placement information for threat scanners to mitigate potential risks. For example, based on a prediction by the machine learning model of the flow of potential threats within the computing environment, the security graph-based threat detection tool determines the placement of a threat scanner within the computing environment to monitor the predicted flow. In other embodiments, the security graph-based threat detection tool determines what data and/or data types to scan and/or rescan.

In various embodiments, the security graph based threat detection tool generates the security graph based on log data obtained from the computing environment. For example, the security graph includes a directed graph with a source node, that has only outgoing edges, and a sink node that has only ingoing edges. In various embodiments, the security graph is enriched and or augmented with additional information such as a capacity, permissions, data type, access history, type of access, critical computing resources, sensitive data, or any other information suitable for determining and/or mitigating potential threats. In various embodiments, the security graph enables the security graph-based threat detection tool to model both edges as potentially allowing data movement (e.g., an edge describing routed traffic) and actual movement, as seen in active traffic (e.g., data plane and/or control plane logs). Furthermore, in some embodiments, source and sink nodes can be virtual (e.g., source is a general representation of the Internet, connected to all nodes exposed to public access) or specific nodes with required properties. Analyzing the resulting flow model, for example, the security graph-based threat detection tool generates predictions indicating how potential threats can travel within the computing environment to reach critical assets, describes threats that are spreading paths, suggests optimal scanning patterns, provides alerts associated with potential threats, and otherwise mitigates threats.

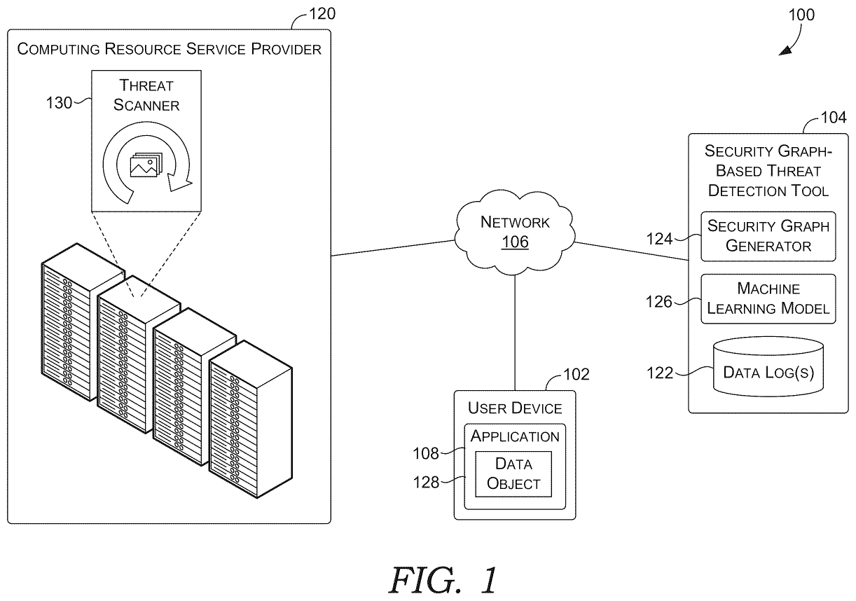

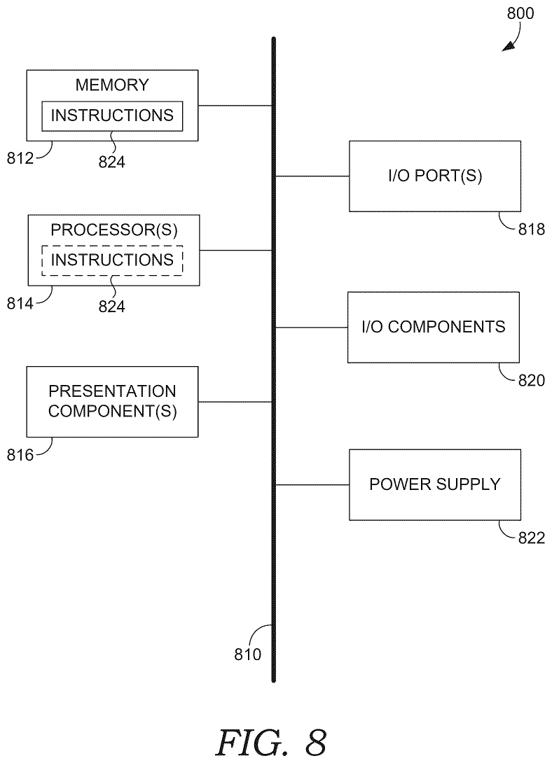

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 8.

It should be understood that operating environment 100 shown in FIG. 1 is an example of one suitable operating environment. Among other components not shown, operating environment 100 includes a user device 102, a security graph-based threat detection tool 104, a computing resource service provider 120, a threat scanner 130, and a network 106. Each of the components shown in FIG. 1 can be implemented via any type of computing device, such as one or more computing devices 800 described in connection with FIG. 8, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the computing resource service provider 120 includes multiple server computer systems cooperating in a distributed environment to perform the operations described in the present disclosure. Furthermore, in some embodiments, the security graph-based threat detection tool 104 is implemented as a component and/or service of the computing resource service provider 120. In one example, the security graph-based threat detection tool 104 is implemented as a service of the computing resource service provider 120.

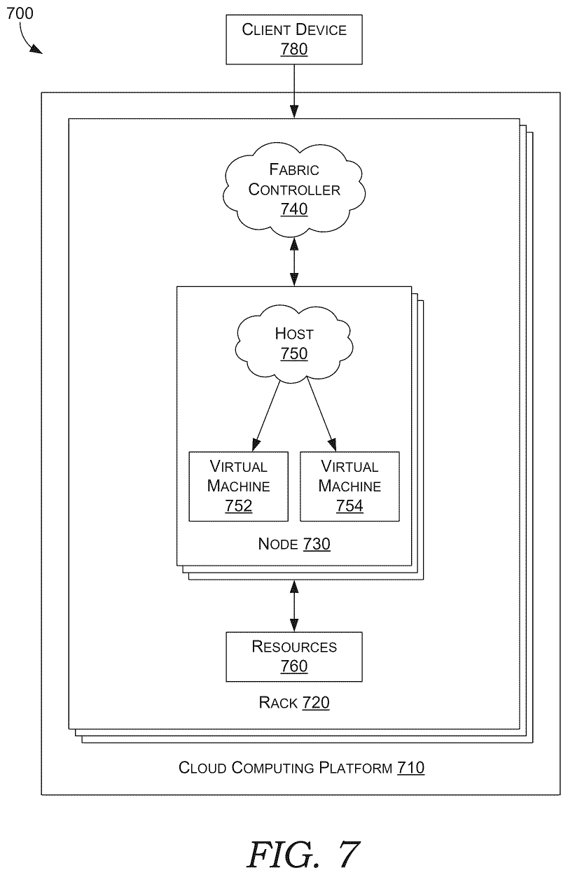

In various embodiments, the computing resource service provider 120 provides a range of computing services over the network 106 using computing resources as described below in connection with FIG. 7. For example, these services include infrastructure as a service (IaaS), platform as a service (PaaS), and software as a service (SaaS). In various embodiments, the computing resource service provider 120 provides virtualized computing resources such as virtual machines, storage, and networking. In addition, the computing resource service provider 120, in an embodiment, provides a platform allowing customers to develop, run, and manage applications, such as the application 108. In various embodiments, the computing resource service provider 120 provides users with computing resources to operate at least a portion of a computing environment. For example, a user can utilize one or more services of the computing resource service provider to connect, via the network, virtual machines, containers, storage devices, and/or other computing resources to a data center and/or server computer system operated by the user (e.g., a hybrid cloud and on-premises computing environment).

User device 102 can be any type of computing device capable of being operated by an entity (e.g., individual or organization) and that obtains data from security graph based threat detection tool 104 and/or computing resources that can be facilitated by the computing resources service provider 120. The user device 102, in various embodiments, has access to or otherwise maintains a data object 128 that stores data. In various embodiments, the data object 128 encapsulates data in a structured format and/or unstructured format, often including both the data itself and metadata that describes its properties and relationships. In one example, the data object 128 represents various types of information, such as files, database records, applications, executable code, and/or multimedia content. In various embodiments, the data object 128 includes malicious code (e.g., malware, ransomware, etc.) that is a potential threat to computing resources. In various embodiments, the application 108 is capable of communicating the data object 128 over the network to computing resources of the computing resource service provider 120. For example, the application 108 is a front-end application that allows users to interact with services of the computing resource service provider 120.

In some implementations, user device 102 is the type of computing device described in connection with FIG. 8. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102, the computing resource service provider 120, and/or the security graph-based threat detection tool 104. For example, the application 108 obtains the data object 128 and provides the data object 128 to the computing resource service provider 120 for storage in a computing environment including the threat scanner 130. In some implementations, the application 108 comprises a web application, which can run in a web browser, and can be hosted at least partially on the server side of the operating environment 100. In addition, or instead, the application 108 can comprise a dedicated application, such as an application being supported by the user device 102 and the security graph-based threat detection tool 104 and/or the computing resource service provider 120. In some cases, the application 108 is integrated into the operating system (e.g., as a service). It is therefore contemplated herein that “application” be interpreted broadly.

For cloud-based implementations, for example, the application 108 is utilized to interface with the functionality implemented by the security graph-based threat detection tool 104. In some embodiments, the components, or portions thereof, of the security graph-based threat detection tool 104 are implemented on the user device 102 or other systems or devices. In one example, data logs 122 are generated by computing resources provided by the computing resource service provider 120 and obtained by the security graph-based threat detection tool 104. Thus, it should be appreciated that the security graph-based threat detection tool 104, in some embodiments, is provided via multiple devices arranged in a distributed environment that collectively provide the functionality described herein. Additionally, other components not shown can also be included within the distributed environment.

As illustrated in FIG. 1, the security graph based threat detection tool 104 includes a security graph generator 124, a machine learning model 126, and data logs 122. In various embodiments, the security graph generator 124 generates a security graph that includes a representation of the security posture of a computing environment. For example, the security graph generator 124, based on the data logs 122, generates a mapping of entities (such as virtual machines, storage accounts, user identities, applications, and/or other computing resources) and the interactions (such as data flows, access permissions, and network connections) between entities. In various embodiments, the security graph generator 124 enriches the security graph with data from control plane logs (such as administrative actions and configurations) and data plane logs (such as recent data movements and operations). In one example, the resulting graph contains nodes representing assets and edges representing relationships and data flows. As described below, by analyzing this graph using the machine learning model, security administrators can identify vulnerabilities, predict potential attack paths, and optimize security measures (such as placement of the threat scanner 130) to protect computing resources for exposure to potential threats and/or risks such as the data object 128.

In various embodiments, the threat scanner 130 includes software or other executable code to detect, analyze, and mitigate malicious software within a computing environment. In one example, the threat scanner 130 is deployed within the computing environment based on placement information determined by the machine learning model 126 to monitor data traffic and file activities. In various embodiments, the threat scanner 130 operates by comparing data objects (e.g., files) and/or data packets against a database of known malware signatures, as well as employing heuristic analysis and behavioral monitoring to identify suspicious activities. In one example, as a result of detecting potential threats, the threat scanner 130 can quarantine or remove malicious files, generate alerts for security administrators, and provide detailed reports for further investigation.

In various embodiments, the data logs 122 include records that capture detailed information about activities and events within the computing environment. For example, control plane logs document administrative actions and configurations, such as user authentication, resource provisioning, permission, and/or policy changes. In various embodiments, the data logs 122 include various types of data such as timestamps, user identification (ID) information, action types, and affected resources. In some embodiments, data plane logs track the data flow and operations, such as network traffic, file access, and application transactions. In such embodiments, the data logs 122 include information such as a source and/or destination network addresses, data packet sizes, and operation results. In various embodiments, the data logs 122 are generated automatically by system components and/or services providing a comprehensive audit trail for monitoring, troubleshooting, and security analysis of computing resources within the computing environment.

In an embodiment, the machine learning model 126 is trained to model network flow data and/or predict the movement of data (such as the data object 128) across the network 106 and/or computing resources of the computing environment. For example, the user device 102 causes, through the application 108, the data object 128 to be stored in a datastore provided by the computing resource service provider 120. The machine learning model 126, in various embodiments, uses various techniques such as graph theory and deep learning to train the machine learning model 126 and/or generate predictions. In one example, the machine learning model 126 includes a Graph Neural Network (GNN) that is trained to process and analyze the structure of the security graphs that includes nodes representing computing resources (such as devices, servers, and applications) and edges representing connections between the nodes (such as data flows between a source node and a sink node). Continuing this example, the GNN learns patterns and relationships within the security graph by aggregating information from neighboring nodes and edges, enabling it to generate predictions of data movement within the computing environment. In various embodiments, the machine learning model is trained on historical network flow data and/or the data logs 122. In such embodiments, once training is completed, the machine learning model 126 predicts potential future data paths that are used to detect security threats such as the path of malicious code and/or other anomalies indicative of security threats.

In various embodiments, the machine learning model 126 includes a multi-modal generative machine learning model that takes multi-modal inputs such as the security graph, data logs 122, natural language prompts, and/or other data and generates an output. For example, the machine learning model 126 includes a multi-modal language model such as a large language model, medium language model, and/or small language model. In various embodiments, the machine learning model 126 analyzing the security graph to predict paths through which malware, ransomware, and/or other malicious code might spread and identify critical nodes that serve as bottlenecks or hubs in the computing environment. In one example, the predictions generated by the machine learning model 126 enables the security graph-based threat detection tool 104 to determine and/or optimize the placement of the threat scanner 130. For example, the security graph-based threat detection tool 104 ensures that scans are conducted at strategic points (such as bottlenecks, hubs, critical computing resources, etc.) to maximize detection efficiency while adhering to budget constraints.

In various embodiments, the computing environment and/or computing resource service provider 120 is constrained based on an amount of computing resources (such as virtual machine, containers, computing devices, etc.) that otherwise can be used to perform the operations of the threat scanner 130. For example, instantiating a container to execute the threat scanner 130 utilizes computing resources that would otherwise be performing operations of the computing environment. In various embodiments, users specify an amount of computing resources that are used to execute the operation of the threat scanner 130. In one example, the user specifies a number of threat scanners 130 to be deployed within the computing environment. In another example, the user specifies a percentage of the computing environment to be protected using the threat scanner 130.

In various embodiments, the machine learning model 126 and/or the security graph-based threat detection tool 104 determines a number of nodes of the security graph that represent the optimal placement for the threat scanner 130. In one example, the machine learning model 126 determines the top k nodes. In various embodiments, the nodes for threat scanner 130 placement are determined by taking nodes out of the security graph and determining a number of remaining paths between sources and sinks, the more paths that are removed by removing a particular node indicates that the node is the more important relative to other nodes. In various embodiments, stochastic analysis using random walks is used to determine relative importance of nodes of the security graph. In addition, in some embodiments, certain types of nodes can be filtered out or otherwise not included in analysis when determining placement of the threat scanner 130.

In addition, in various embodiments, the machine learning model 126 predicts or otherwise determines what types of data and/or data objects to scan using the threat scanner. For example, the machine learning model 126 and/or threat scanner 130 limit scanning to data objects that pose a risk and/or are executable within the computing environment. In some embodiments, the security graph is updated and the placement of the threat scanner 130 is reevaluated. For example, the security graph is updated periodically, on demand, in response to a trigger (such as adding new computing resources to the computing environment), updated data logs 122, and/or another event. Continuing this example, the security graph-based threat detection tool 104 then provides the updated security graph to the machine learning model 126 to generates and/or update the predictions. In one example, the machine learning model 126 generates and/or updates the predictions based on the portion of security graph (such as a sub-graph) that has changed.

Furthermore, in various embodiments, the machine learning model 126 is provided various constraints as an input. The machine learning model 126 then determines placement of the threat scanner 130 based on the constraints. For example, the machine learning model is provided an amount of computing resources available to the threat scanner 130 (such as a number of virtual machines that can be used as threat scanners within the computing environment) and ranks the nodes for placement of the threat scanner 130 based on the amount of computing resources available. In addition, the machine learning model 126, in some embodiments, determines particular triggering events and various locations that trigger a scan by the threat scanner 130. In one example, in response to the data object 128 being uploaded, the machine learning model 126 determines, based on a location the data object 128 is uploaded to, whether to scan the data object based on the amount of computing resources available. In yet other embodiments, the constraint represents an amount of computing resources to be covered or otherwise protected by the threat scanner 130. In one example, the user indicates to the machine learning model that eighty percent of the computing environment is to be protected by the threat scanner 130. As a result, the machine learning model 126 generates and/or predicts placement information of the threat scanners 130 to cover the indicated amount of computing resources.

Additionally, in some embodiments, the security graph-based threat detection tool 104 provides a mechanism for prioritizing security alerts and recommendations based on the likelihood of a particular security risk spreading. For example, malware that is uploaded to an archival datastore may pose less risk than malware uploaded to a virtual machine. As a result, in some embodiments, alerts related to security risks (such as uploads and downloads of data objects 128) are ranked according to the potential impact on sensitive resources, allowing security administrators to focus on the most critical threats. For example, the security graph-based threat detection tool 104 selects the highest k ranked nodes for placement of the threat scanner(s) 130.

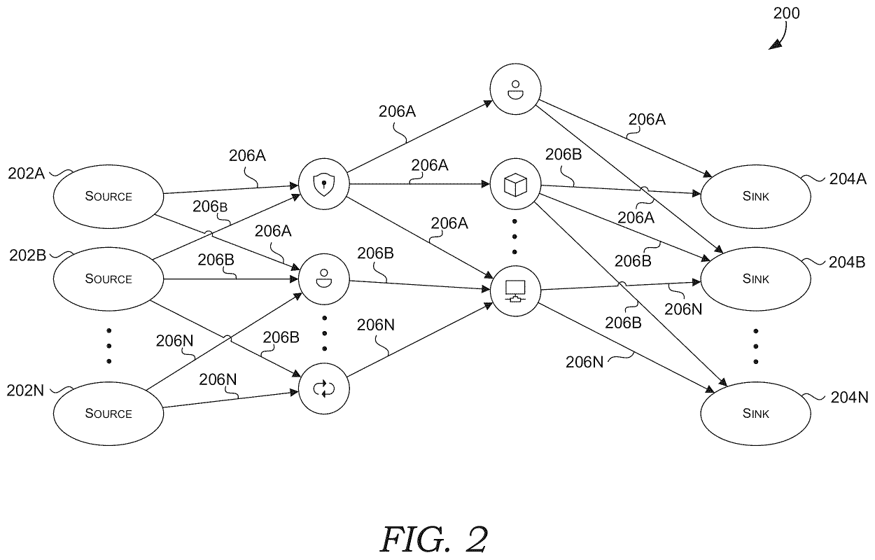

FIG. 2 depicts an environment 200 where a security graph representing a computing environment is generated based on data logs, in accordance with an embodiment. For example, as illustrated in FIG. 2, the security graph includes sources 202A-202N, sinks 204A-204N, and edges 206A-206N. In various embodiments, the sources 202A-202N include computing resources that can contain malicious code such as malware and/or ransomware. For example, the sources 202A-202N include virtual machines, storage devices, databases, containers, user devices, storage containers, websites, email servers, compromised users, or any other computing resources suitable for storing and/or maintaining data. In various embodiments, the sinks 204A-204N include computing resources capable of executing malicious code such as malware and/or ransomware. For example, sinks 204A-204N include virtual machines, containers, user devices, network devices, server computer systems, or any other computing resources capable of executing code that could otherwise be put at risk of a security threat.

In various embodiments, the security graph includes a complex or non-uniform graph. For example, nodes (such as the sources 202A-202N, sinks 204A-204N, and intermediate nodes) and edges have varying properties and structures, rather than being homogeneous. In various embodiments, nodes of the security graph represent different types of entities (such as servers, users, applications, network devices, services, or other components of the computing environment) and the edges 206A-206N can represent different types of relationships (such as data flows, access permissions, reads, writes, user access attempts, network connections, or other relationships within the computing environment). The complexity arises from the diverse nature of the nodes and the edges, as well as the intricate patterns of connectivity and interaction among them. Non-uniform graphs are often used to model real-world systems, such as social networks, biological networks, and cloud security environments, where the elements and their interactions are not uniform or regular.

In various embodiments, generating the security graph includes generating an asset graph representing computing resources and relations between them such as traffic routing and data movement. For example, an asset graph is generated based on the computing resources provided by a computing resource service provider. In an embodiment, a flow network model is generated based on the asset graph. For example, the flow network model describes and/or represents movement of data (and potential malware) between computing resources represented in the security graph. In various embodiments, the asset graph and flow network model are generated based on data logs such as the data logs 122 described above in connection with FIG. 1.

In various embodiments, one or more algorithms (such as augmentation and residual paths, capacity and bottlenecks, or other flow chart algorithms) are used to determine information and/or insights associated with the security graph. For example, a bottleneck in a security graph indicates assets that serve as hubs for spreading malicious code and/or other potential threats or attacks. Continuing this example, in order to provide optimal coverage under various budget constraints, threat scanners are enabled on computing resources corresponding to the bottleneck. In various embodiments, the security graph indicates potential malicious code spread paths, allowing a machine learning model to predict targets and recommend mitigations (such as disrupting attack vectors, hardening computing resources, deploying threat scanners, etc.) at optimal places in optimal times.

In various embodiments, nodes representing computing resources are ranked based on contribution to the flow (as nodes representing sources, hubs, sinks, etc.) and various security features. For example, the machine learning model generates recommendations such as where to scan for threats and what types of data to scan. In another example, the machine learning model generates alerts indicating vulnerabilities and/or computing resources that can be exposed to potential threats. In various embodiments, the security graph enables the machine learning model to generate insights that are added to nodes in a security graph. For example, a tag or other metadata is added to a node indicating a potential threat, bottleneck, etc. Furthermore, in an embodiment, the machine learning model, based on the security graph, determines malware spreading paths (such as attack paths) representing connections between malicious code sources and critical computing resources vulnerable to malicious code.

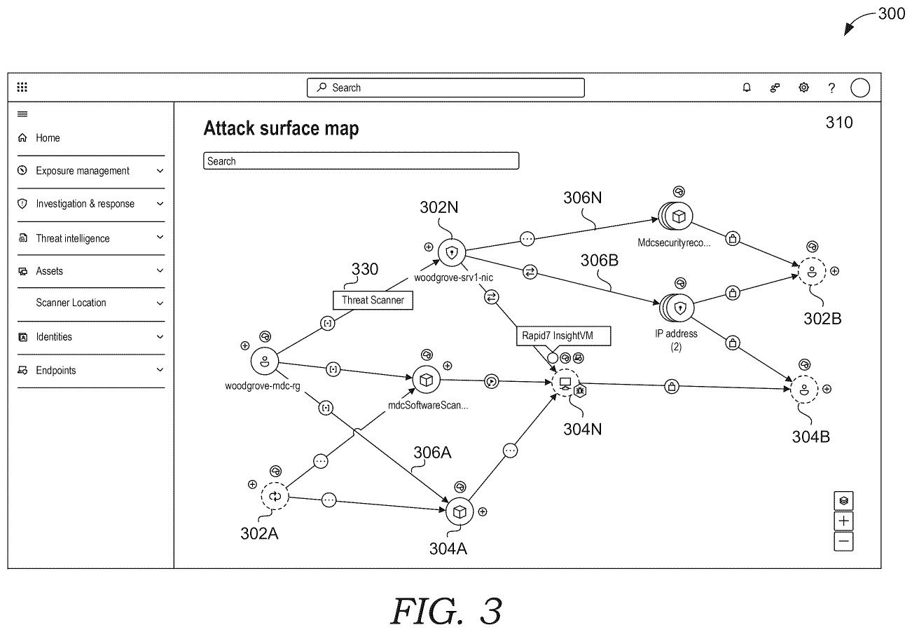

FIG. 3 depicts an environment 300 where a security graph representing a computing environment is presented in a user interface 310, in accordance with an embodiment. For example, as illustrated in FIG. 3, the security graph includes sources 302A-302C, sinks 304A-304C, and edges 306A-306N. In various embodiments, the security graph including the sources 302A-302C, the sinks 304A-304C, the edges 306A-306N, and the node displayed in the user interface 310 represent a computing environment. In addition, in various embodiments, the user interface 310 displays the location of threat scanners 330.

In various embodiments, the user interface 310 enables the user to interact with the security graph-based threat detection system tool 104 as described above in connection with FIG. 1. For example, the user can interact with the user interface 310 and cause the security graph to be generated. In other examples, the user through the user interface 310 provides computing resource budget and/or other constraints as an input to a machine learning model that generated recommendations for threat scanner locations and/or alerts indicating potential security threats. In various embodiments, the user interface 310 provides users with alerts and/or otherwise enables users to interact with the security graph-based threat detection tool.

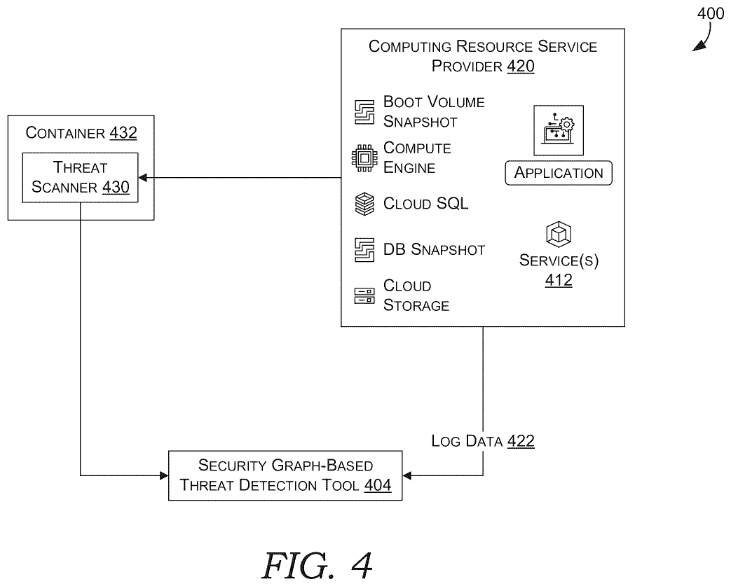

FIG. 4 depicts an environment 400 in which a security graph-based threat detection tool 404 determines placement of a threat scanner 430 in accordance with an embodiment. For example, the security graph-based threat detection tool 404 obtains data logs 422 from computing resources provided by a computing resource service provider 120. In various embodiments, computing resource service provider 120 exposes various services 412 that enable users to access computing resources and/or generate a computing environment including virtualized computing resources like virtual machines, storage, networking, executing applications, databases, and/or other computing resources. In one example, the computing resource service provider 120 provides additional services 412 such as data analytics for processing large datasets; security services for identity and access management, encryption, and threat detection, networking solutions for managing network resources; and scalable storage solutions for data backup and disaster recovery. The computing resource service provider 120, in various embodiments, allows users to generate the computing environment to perform various operations.

In addition, in various embodiments, the computing resource service provider 120 provides a container service that is used to provide a container 432 to execute the threat scanner 430. In one example, the container 432 is a lightweight, standalone, and executable software package that includes software, such as executable code, system tools, libraries, and settings. In an embodiment, the container 432 is isolated from other computing resources and the host system, ensuring that the container 432 executes consistently across different computing environments. In an embodiment, the container 432 is instantiated from an image that contains the threat scanner executable code and dependencies and executes the executable code in an isolated environment. The threat scanner 430, in an embodiment, within the container 432, processes data by at least scanning files and network traffic for malicious activity.

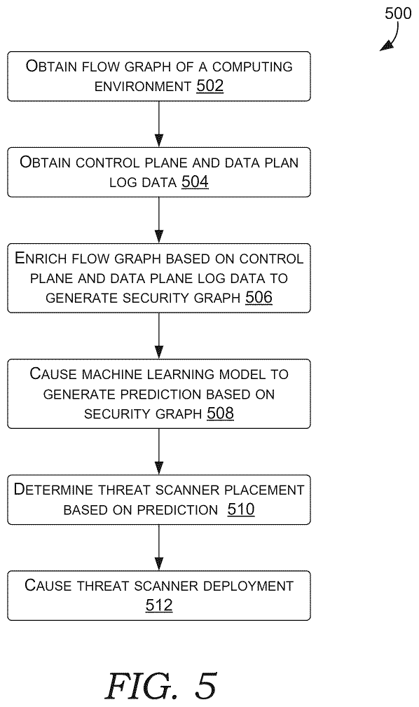

FIG. 5 is a flow diagram showing a method 500 for determining location information for threat scanners within a computing environment in accordance with at least one embodiment. The method 500 can be performed, for instance, by the security graph-based threat detection tool 104 of FIG. 1. Each block of the method 500 and 600 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, the system implementing the method 500 generates a graph of a computing environment. As described above in connection with FIG. 1, in various embodiments, computing resources within the computing environment are represented as nodes in the graph and edges between the nodes indicate relationship between the nodes. For example, the nodes represent computing resources, and the edges represent the flow of data between the computing resources. In another example, the nodes represent users within the computing environment, and the edges represent permission and/or access rights.

At block 504, the system implementing the method 500 obtains control plane and data plane logs. For example, the computing resources in the computing environment generate log data and provide the log data to the security graph-based threat detection tool. At block 506, the system implementing the method 500 enriches the graph based on the control plane log data and the data plane log data. In one example, the graph is updated to indicate and/or aggregate the most recent data flows within the computing environment. In another example, the graph is updated to include permissions associated with particular nodes and/or edges. In various embodiments, the graph is enriched to generate a security graph that represents the flow and/or spread of potential attacks and/or threats within the computing environment.

At block 508, the system implementing the method 500 causes a machine learning model to generate predictions based on the security graph. For example, the machine learning model generates a ranking of the nodes in the security graph based on the nodes importance to the security of the computing environment. In various embodiments, the machine learning model is trained to rank nodes based on optimal placement of the threat scanner within the computing environment. In various embodiments, the machine learning model generates predictions indicating particular data types to scan, users, devices, particular intervals of time to scan, and/or other information suitable for mitigating security threats within the computing environment.

At block 510, the system implementing the method 500 determines threat scanner placement based on the predictions. For example, the system implementing the method 500 selects the top k nodes to place threat scanners within. In other examples, the system implementing the method 500 selects the placement of the threat scanners based on one or more constraints of the computing environment such as an amount of available computing resources. At block 512, the system implementing the method 500 causes the threat scanners to be deployed. For example, a virtual machine, container, or other platform is instantiated to execute the threat scanner.

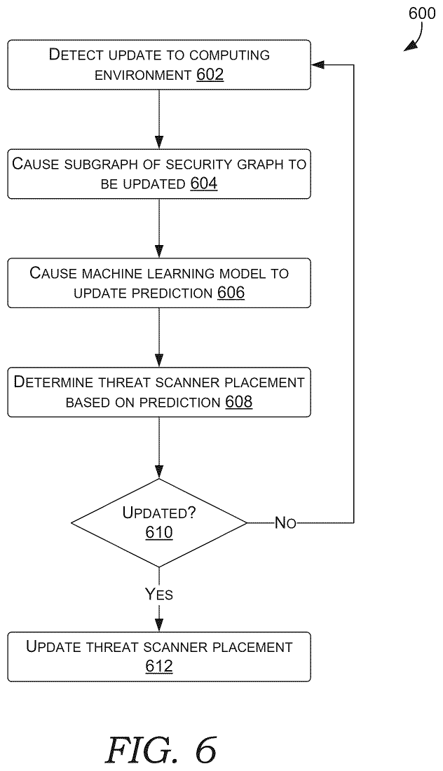

FIG. 6 depicts an example process flow for updating a security graph and determining location information for threat scanners within a computing environment, in accordance with at least one embodiment. At block 602, the system implementing the method 600 detects an update to a computing environment. For example, a new user, computing resource, entity, or other modification to the computing environment that is monitored by the security graph-based threat detection tool is detected.

At block 604, the system implementing the method 600 causes a subgraph of the security graph to be updated. For example, if a node or an edge of the security graph is modified, instead of regenerating the entire security graph, only the subgraph that is affected by the modification is updated. At block 606, the system implementing the method 600 causes the machine learning model to update the predictions based on the updated security graph. For example, the machine learning model processes the security graph to determine potential flows for malicious code, critical computing resources, and/or security threats.

At block 608, the system implementing the method 600 determines threat scanner placement based on the information generated by the machine learning model. For example, if the ranking of the nodes generated by the machine learning model has changed, the system implementing the method 600 determines that the placement of the threat scanner has been updated. At block 610, if the placement information has changed, the system implementing the method 600 continues to block 612. At block 612, the system implementing the method 600 updates the threat scanner placement. For example, the system implementing the method 600 causes a threat scanner to be deployed at another location within the computing environment. Returning to block 610, if the threat scanner placement has not changed, the system implementing the method 600 returns to block 602.

Referring now to FIG. 7, FIG. 7 illustrates an example distributed computing environment 700 in which implementations described in the present disclosure may be employed. In particular, FIG. 7 shows a high-level architecture of an example cloud computing platform 710 that can host a virtualization environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The virtualization environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a tenant infrastructure or tenancy. The terms “service application,” “application,” or “service” are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example. Client device 780 can be configured to issue commands to cloud computing platform 710. In some implementations, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include one or more local area networks (LANs) and/or wide area networks (WANs).

Having described embodiments of the present disclosure, FIG. 8 provides an example of a computing device in which embodiments of the present disclosure may be employed. Computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 8 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 8 and make reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, Random Access Memory (RAM), Read-Only Memory (ROM), Electrically Erasable Programmable Read-Only Memory (EEPROM), flash memory or other memory technology, digital versatile disks (DVDs) or other optical disk storage, magnetic cassettes, magnetic tape, magnetic disk storage or other magnetic storage devices, or any other medium that can be used to store the desired information and which can be accessed by computing device 800. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 812 includes computer storage media in the form of volatile and/or nonvolatile memory. As depicted, memory 812 includes instructions 824. Instructions 824, when executed by processor(s) 814, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built-in. Illustrative components include a microphone, joystick, game pad, satellite dish, scanner, printer, wireless device, etc. I/O components 820 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 800. Computing device 800 may be equipped with depth cameras, such as stereoscopic camera systems, infrared camera systems, RGB camera systems, and combinations of these, for gesture detection and recognition. Additionally, computing device 800 may be equipped with accelerometers or gyroscopes that enable detection of motion. The output of the accelerometers or gyroscopes may be provided to the display of computing device 800 to render immersive augmented reality or virtual reality.

Embodiments presented herein have been described in relation to particular embodiments, which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further subparts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
generating a security graph of a computing environment based on a control plane data log and a data plane data log, where the security graph includes a plurality of nodes, the plurality of nodes includes a source representing a first computing resource capable of storing malicious code and a sink representing a second computing resources capable of executing the malicious code, the security graph includes at least one edges between nodes of the plurality of nodes of the security graph where the at least one edge represent a relationship between connected nodes where data is capable of being transmitted along the edge;
causing a machine learning model to generate a prediction based on the security graph, the prediction indicates a flow of the malicious code within the computing environment;
determining placement information for a threat scanner based on the prediction; and
causing the threat scanner to be deployed within the computing environment based on the placement information.

2. The method of claim 1, wherein the method further comprises:
detecting a modification to the computing environment;
updating the security graph based on the modification to generate an updated security graph; and
causing the machine learning model to generate a second prediction based on the updated security graph.

3. The method of claim 2, wherein causing the machine learning model to generate the second prediction further comprises providing as an input a subgraph of the updated security graph where the subgraph corresponds to the modification.

4. The method of claim 2, wherein the method further comprises:
determining an update to the placement information for the threat scanner based on the prediction; and
causing the threat scanner to be redeployed based on the update to the placement information.

5. The method of claim 1, wherein generating the security graph further comprises aggregating recently accessed computing resources to indicate data flow within the security graph.

6. The method of claim 1, wherein generating the security graph further comprises adding additional information to nodes of the security graph, where the additional information indicates at least one of: permissions associated with the nodes, sensitive information associated with the nodes, and a security risk associated with the nodes.

7. The method of claim 1, wherein generating the security graph further comprises enriching the nodes of the security graph with permissions associated with users of the computing environment.

8. A non-transitory computer-readable medium storing executable instructions embodied thereon, that, as a result of being executed by a processing device, cause the processing device to perform operations comprising:
obtaining a graph indicating computing resources within a computing environment;
obtaining control plane log data and data plane log data generated by the computing resources within the computing environment
modifying the graph based on the control plane log data and the data plane log data to include a source node representing a first computing resource that is capable of storing malicious code and a sink node representing a second computing resource that is capable of executing the malicious code, where the graph includes at least one edge indicating a flow of data within the computing environment;
causing a machine learning model to generate a ranking of at least one node within the graph;
determining placement information for a threat scanner based on the ranking; and
causing the threat scanner to be deployed within the computing environment based on the placement information.

9. The medium of claim 8, wherein determining the placement information for the threat scanner based on the ranking further comprises determining placement information based on a highest ranked node.

10. The medium of claim 8, wherein causing the machine learning model to generate the ranking further comprises causing the machine learning model to generate a recommendation of a type of data to scan using the threat scanner.

11. The medium of claim 8, wherein causing the machine learning model to generate the ranking further comprises causing the machine learning model to generate a recommendation of an interval of time to scan for the malicious code.

12. The medium of claim 11, wherein the machine learning model is trained using stochastic analysis.

13. The medium of claim 8, wherein the computing environment includes at least one computing resource provided by a computing resource service provider.

14. The medium of claim 8, wherein the machine learning model is a Graph Neural Network (GNN).

15. The medium of claim 8, wherein causing the machine learning model to generate the ranking further comprises causing the machine learning model to generate the ranking based on an amount of computing resources within the computing environment to be protected by a plurality of threat scanners including the threat scanner.

16. A system comprising:
a memory component; and
a processing device coupled to the memory component, the processing device to perform operations comprising:
obtaining data logs generated by computing resources within a computing environment;
based on the data logs, generating a security graph of the computing, the security graph including a source node that represents a first computing resource within the computing environment capable of storing malicious code, a sink node that represents a second computing resource within the computing environment capable of executing the malicious code, and a plurality of edges between a plurality of nodes of the security graph where the source node and the sink node are members of the plurality of nodes;
causing a machine learning model to generate a prediction of a flow of the malicious code within the computing environment based on the security graph;
determining a ranking of nodes of the plurality of nodes in the security graph based on the prediction; and
causing a threat scanner to be deployed within the computing environment based on the ranking.

17. The system of claim 16, wherein determining the ranking further comprises determining the ranking based on a budget of computing resources available within the computing environment.

18. The system of claim 16, wherein determining the ranking further comprises determining the ranking based on a percentage of the set of computing resources within the computing environment to be protected by the threat scanner.

19. The system of claim 16, wherein the operations further comprise:
determining a modification to the computing environment;
in response to the modification, updating a subgraph of the security graph associated with the modification; and
causing the machine learning model to generate a second prediction of a second flow of the malicious code within the computing environment based on the subgraph.

20. The system of claim 16, wherein the data logs include control plane data logs and data plane data logs.
